(19) United States
(12) Patent Application Publication
(10) Pub. No.: US 2005/0026069 A1
(43) Pub. Date: Feb. 3, 2005

(54) Solventless thermosetting photosensitive via-filling material

(76) Inventor: Todd Yeh, Tao-Yuan City (TW)

Correspondence Address: SUPREME PATENT SERVICES, POST OFFICE BOX 2339, SARATOGA, CA, 95070, US

(21) Appl. No.: 10/632,732

(22) Filed: Jul. 31, 2003

(51) Int. Cl. G03C 1/76

(52) U.S. Cl. 430/270.1

(57) ABSTRACT

A via-filling material improves a via-filling process in manufacturing multi-layered printed circuit boards. The via-filling material is capable of undergoing UV pre-cure and thermal post-cure step. Exposed to ultraviolet light, the via-filling material filled up the two ends of the via form solid barrier films so that the inside via-filling material will not flow out during a thermal post curing process due to an lower viscosity of said material. The dual-cure treatment resolves the problems of polishing, sagging and bubbling in the via-filling process and ensures the integrity of the filling material. As a result, the via-filling material with smooth surface and a solid inside without void or hole therein formed.

### BACKGROUND OF THE INVENTION

1. Field of the Invention

The present invention relates to thermosetting photosensitive material, and specifically to a thermosetting photosensitive material for via-filling process in manufacturing printed circuit boards.

2. The Prior Arts

In recent years, owing to the surging demands of mobile phones, personal electronic organizers and laptops, consumers are increasingly demanding electronic products lighter, thinner, and smaller. The printed-circuit-board (PCB) industry, which has to support the electronic industries in their development, are also pushed towards manufacturing processes that are capable of handling this trend. To make lighter, thinner, and smaller electronic products, people pack more circuit density onto the ever-decreasing board area, or so-called high-density-integration. The technology of multi-layered boards manufacturing also plays an essential role in the revolution towards high-density-integration.

Particular to the multi-layered board manufacturing technology, sets of via have to be drilled to leave room for the formation of electronic connection between different layers. As it might sound perplexing to those who know nothing about it, these sets of via then have to be filled generally by some polymeric materials after the connections made and then proceed to a thermal curing process at a temperature of 150° C. for about 30-60 minutes. The purpose of via-filling is to protect the electronic connection within the via. Without the via-filling material, the connector within via is subjected to oxidation by air trapped therein, which in turn leads to breaking of signal transmission and renders the product useless. Therefore, the via-filling process is really a critical step in the multi-layered board manufacturing processes.

Though it seems simple, via-filling process is complicated. Sometimes, it is really a challenging step. Generally speaking, problems encountered are such as bubbles inside the filling, volcanoes on the surface and recessed or bulged filling surface profiles along the plane of circuit patterns. Until now, the industry-wise yield-rate of this step is still far from satisfactory. A key factor for resolving this issue lies in the filling material itself. If the composition of the filling material can be improved so that it does not expand or contract much during the subsequent curing step, then there should not be much of surface bulge or recess. Also, if the solvent can be removed from the filling composition, there would not be problems of volcanoes and bubbles, which generally form as solvent evaporates.

FIG. 1 illustrates a via structure formed by a through hole in a conventional printed circuit board (PCB) manufacturing process. The via structure comprises a substrate (10), a via (20) formed by a through hole on the substrate (10), a circuit pattern layer (30) formed on the substrate (10) by forming a copper ring (21) on the via wall of the substrate (10).

As indicated in FIG. 2, idealistically, the filling is solid and void-free after cross-linking of the via-filling material (40). Furthermore, the surface on both ends of the cylinder formed within the surrounding copper ring (21) must be a smooth surface (41) so as to avoid problems in the subsequent manufacturing process. However, smooth surface is difficult to acquire in practice. One common problem is the recess on the filling surface, which is illustrated in FIG. 3, where a recess (42) is found on the via-filling material (40) after cross-linking.

Commercially available via-filling materials include both solvent and solvent-less types. In some printed circuit board manufacturing processes with less stringent requirements, people use solder resistant material for via filling. Since the solvent content for most commercial solder resistant products is relatively high, i.e. up to 25%, which results in voids or recessed surfaces. Such problems are due to evaporation of solvent in the subsequent baking process. The via-filling material shrinks as the loss of the volume of solvent, thus results in recessed surfaces or voids. Therefore, the existence of solvent is detrimental to the via-filling process.

To completely resolve problems occurring in the curing step, a solvent-less product is selected undoubtedly. Unfortunately, current commercial via-filling products still contain certain problems, so that the yield rate is largely limited. Sagging is a common problem, which is the flowing of the filling material out of via during the curing process. Sagging is caused by viscosity changes. The viscosity of the uncured filling material (40) is low at the curing temperature, such as 150° C. The filling material thus tends to flow out of via along the vertically mounted PCB (10) under the influence of the gravity, as shown in FIG. 4. As a result, the lack of coverage of the filling material along the top edge of via and excessive coverage along the bottom edge of via forms.

### SUMMARY OF THE INVENTION

Accordingly, the present invention is directed to a solventless thermosetting photosensitive material that substantially obviates the above-mentioned problems in the via-filling process of manufacturing printed circuit board.

To achieve these and other advantages and in accordance with the purpose of the present invention, as embodied and broadly described herein, a solventless thermosetting photosensitive via-filling material according to the present invention comprises:
one or more liquid epoxy resins;
one or more monomers;
one or more photo-initiators; and
one or more epoxy resin curing agents.

Furthermore, the solventless thermosetting photosensitive via-filling material comprises one or more optional inorganic fillers for adjusting physical properties thereof such as electrical insulation, acid resistance, Theological properties, etc.; and one or more optional organic adjuvants for achieving desired processing characteristics for the via-filling step.

For more detailed information regarding advantages and features of the present invention, examples of preferred embodiments will be described below with reference to the annexed drawings.

### BRIEF DESCRIPTION OF THE DRAWINGS

The related drawings in connection with the detailed description of the present invention to be made later are described briefly as follows, in which:

FIG. 1 illustrates a via structure formed by a through hole in a conventional printed circuit board (PCB) manufacturing process;

FIG. 2 illustrates a via-filling material after curing;

FIG. 3 illustrates a recess on the via-filling material surface; (00171 FIG. 4 illustrates the problem of sagging caused by the lowering of viscosity of the filling material at curing temperature. It shows that the top edge lacks in coverage of filling material, while the lower edge is excessively covered with filling material; and

FIGS. 5(A)-5(C) are schematic views of examples for filling up a via with a solventless thermosetting photosensitive material in the process of manufacturing printed circuit board.

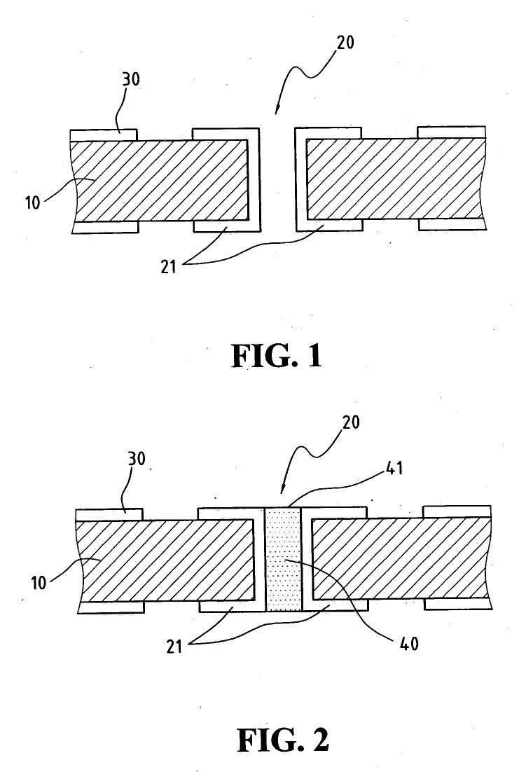

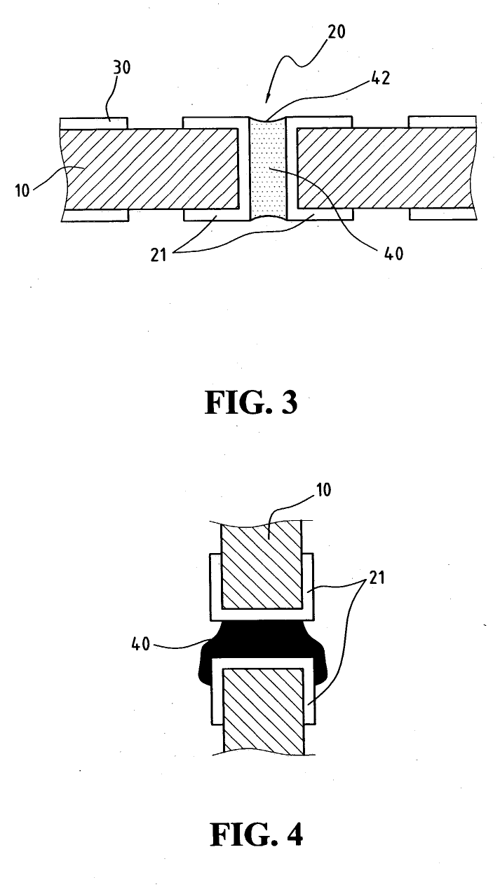

### DETAILED DESCRIPTION OF THE INVENTION

Preferred embodiments of the present invention will now be described in further detail. It should be understood that these examples are intended to be illustrative only and that the present invention is not limited to the conditions, materials or devices recited therein.

A solvent-less thermosetting photosensitive via-filling material according to the present invention, based on 100 parts of the epoxy resin, comprises:
one or more liquid epoxy resins;
one or more monomers;
one or more photo initiators; and
one or more epoxy resin curing agents.

Furthermore, one or more optional inorganic fillers and organic adjuvants are added to achieve the desired properties.

Liquid epoxy resins as used herein comprise bisphenol-A epoxy resins, bisphenol-F epoxy resins, blends of bisphenol-A and bisphenol-F epoxy resins, phenol Novolac epoxy resins, rubber-modified epoxy resins, cycloaliphatic epoxy resins, hydrogenated bisphenol-A epoxy resins, dimmer-modified epoxy resins, flexible EPU modified epoxy resins and other hetero epoxy resins. The amount of liquid epoxy resins is determined by the actual need and referred as 100 parts for calculating the ratio of other compositions.

Bisphenol-A epoxy resins as used herein include DEN-330 from Dow, Epikote-828 from Shell, LER-840 from LG and NPEL-127 from Nan-ya. Bisphenol-F epoxy resins include DER-354 from Dow, Epikote-862 from Shell, LER-830 from LG and NPEF-170 from Nan-ya. Blends of bisphenol-A and bisphenol-F epoxy resins include DER-351 and DER-352 from Dow and NPEF-157 from Nan-ya. Phenol Novolac epoxy resins include LER-N730 from LG. Rubber-modified epoxy resins include TSR-960 from LG and NPEL-450 from Nan-ya. Cycloaliphatic epoxy resins include Cyracure-6610 from Dow. Hydrogenated bisphenol-A epoxy resins include EP-4080 from Adeka. Dimmer-modified epoxy resins include LER-1500 from LG and NPER-172 from Nan-ya. Flexible EPU modified epoxy resins include NPER-133 and NPER-133L from Nan-ya.

Monomers as used herein comprise mono-functional monomers, difunctional monomers, trifunctional monomers and tetra and penta-functional monomers. The amount of monomers used is from 2 to 50 parts based on 100 parts of epoxy resin by weight, and preferably in the range of 5 to 50 parts based on 100 parts of epoxy resin by weight, based on 100 parts by weight of the liquid epoxy resins. As the amount of monomers increases, the photosensitivity of the system increases but the solder-resistance decreases.

As used herein, typical examples of mono-functional monomers include allyl methacrylate, tetrahydrofurfuryl methacrylate, 2(2-thoxyethoxy)ethyl acrylate, 2-phenoxyethyl acrylate, and isodecyl acrylate. Typical examples of difunctional monomers include tetraethylene glycol dimethylacrylate, polyethylene glycol dimethacrylate, ethylene glycol dimethacrylate, triethylene glycol dimethacrylate, tetraethylene glycol diacrylate, triethylene glycol diacrylate and tripropylene glycol diacrylate. Typical examples of trifunctional monomers include trinmethylolpropane trimethacrylate, trimethylolpropane triacrylate and tris(2-hydroxyethyl) isocyanurate triacrylate. Typical examples of tetra and penta-functional monomers include dipentaerythritol pentaacrylate, pentaerythritol tetraacrylate, di-trimethylolpropane tetraacrylate.

Photo-initiators as used herein comprise free-radical photo-initiators. Typical examples of free-radical photo-initiators are selected from a group consisting of 2-methyl-1-[4-(methylthio)phenyl]-2-morpholinopropanone, 2-isopropyl thioxanthone, 2-hydroxy-2-methylphenylpropanone, 1-hydroxycyclohexyl phenylketone. They can be used separately or in the form of mixture. The amount of photo-initiators used is from 0.5 to 10 parts by weight based on 100 parts of epoxy resin by weight, and preferably in the range of 1 to 5 parts by weight, based on 100 parts by weight of the liquid epoxy resins.

Epoxy resin curing agents as used herein comprise epoxy resin thermal curing agents. Typical examples of epoxy resin thermal curing agent comprise dicyandiamine, amidoamines, polysulfides, amines, polyamides, aliphatic amines, cycloaliphatic amines, aromatic amines, anhydrides, imidazoles, such as 2-methylimidazole 2,4-diamino-6-(2′-methylimidazolyl-(1′))-ethyl-S-triazine, 2,4-diamino-6-[2′-methylimidazoly-(1′)] ethyl-S-triazine isocyanuric acid addition compound; modified polyamine, such as EH-4070S from Adeka and Ancamine-2014FG from Air Products; and others, such as EH-4337S from Adeka. The amount of epoxy resin curing agent used is 2 to 70 parts by weight based on 100 parts of epoxy resin by weight, preferably 4 to 10 parts by weight, based on 100 parts by weight of said liquid epoxy resin.

For adjusting physical properties, other ingredients such as inorganic fillers are added optionally. Typical examples of inorganic fillers as used herein include silicon dioxide, barium sulfate, mica and talcum powder. The amount of inorganic filler added is 0-200 parts by weight, based on 100 parts by weight of said liquid epoxy resin.

For desired processing characteristics of the via-filling step, one or more optional organic adjuvants can be used, including de-forming agents, thixotropic agents, Theological additives, leveling agents and dyes. The amount of organic adjuvants added is 0 to 50 parts by weight, based on 100 parts by weight of said liquid epoxy resin.

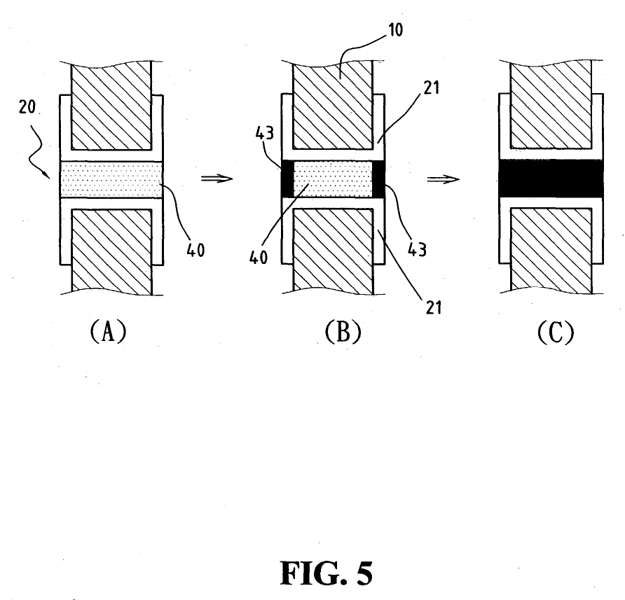

FIGS. 5(A)-5(C) are schematic views of examples for filling up via with a solvent-less thermosetting photosensitive material in the process of manufacturing printed circuit board. According to the present invention, the solventless thermosetting photosensitive material (40) is fill up the via (20) by screen printing on PCB (10), as shown in FIG. 5(A). Then, the PCB (10) is mounted in a 7 kW ultraviolet exposure machine for a short-time exposure. As a result, solid barrier films (43) with a thickness of greater than 50 μm (about ⅕ the thickness of the PCB) form at both ends of the via-filling material, as shown in FIG. 5(B). The solid barrier films prevent the internal solventless thernosetting photosensitive material from flowing out of via. The exposure energy must be high enough so that the integrity of the solid barrier film will not be destroyed during the thermal post-curing process; on the other hand, the energy should not be so high as to scorch the solid barrier films. To form optimal solid barrier films to keep the internal solventless thermosetting photosensitive material from flowing out of via, the exposure energy set is preferably from 0.5 to 5 mJ/cm² for the ultraviolet exposure machine.

After ultraviolet exposure, a thermal curing process is subsequently carried out. Preferably, the thermal curing process is carried out at a temperature of 100-260° C. for at least 3 minutes. The via-filling material (40), after thermal curing, is cylindrical in shape with flat surface profiles and solid interior containing no voids or holes, as shown in FIG. 5(C).

### EXAMPLE 1

A solventless thermosetting photosensitive via-filling material consists of 100 parts by weight bisphenol-A epoxy resins (LG N-730), 6 parts by weight 2,4-diamino-6[2′-methylimidazoly-(1′)] ethyl-S-triazine isocyanuric acid addition compound, 20 parts by weight tris(2-hydroxyethyl) isocyanurate triacrylate, 2 parts by weight 2-methyl-1-[4-(methylthio)phenyl]-2-morpholinopropanone, 0.2 parts by weight 2-isopropyl thioxanthone, 2.5 parts by weight Aerosil R974 and 3 parts by weight Defoamer KS-66.

The solventless thermosetting photosensitive via-filling material is used to fill up the via by screen printing on PCB. Then, the PCB is mounted in a 7 kW ultraviolet exposure machine for a short-time exposure with exposure energy of 1 mJ/cm². As a result, solid barrier films with a thickness of greater than 50 μm form at both ends of the via-filling material. The solid barrier films will prevent the internal solventless thermosetting photosensitive material from flowing out of via.

After ultraviolet exposure, a thermal curing process is subsequently carried out at a temperature of 150° C. for 20 minutes. The solventless thermosetting photosensitive material in via, after thermal curing, is cylindrical in shape with flat surface profiles and solid interior containing no voids or holes.

### EXAMPLE 2

A solventless thermosetting photosensitive via-filling material consists of 100 parts by weight bisphenol-F epoxy resins (Epon-862), 6 parts by weight 2,4-diamino-6[2′-methylimidazoly-(1′)] ethyl-S-triazine isocyanuric acid addition compound, 15 parts by weight trimethylolpropane triacrylate, 2 parts by weight 2-methyl-1-[4-(methylthio)phenyl]-2-morpholinopropanone, 0.2 parts by weight 2-isopropyl thioxanthone, 2.5 parts by weight Aerosil R974 and 3 parts by weight Defoamer KS-66.

The solventless thermosetting photosensitive via-filling material is used to fill up the via by screen printing on PCB. Then, the PCB is mounted in a 7 kW ultraviolet exposure machine for a short-time exposure with exposure energy of 1 mJ/cm². As a result, solid barrier films with a thickness of greater than 50 μm form at both ends of the via-filling material. The solid barrier films prevent the internal solventless thermosetting photosensitive material from flowing out of via.

After ultraviolet exposure, a thermal curing process is subsequently carried out at a temperature of 150° C. for 20 minutes. The solventless thermosetting photosensitive material in via, after thermal curing, is cylindrical in shape with flat surface profiles and solid interior containing no voids or holes.

While the invention has been described in its preferred embodiments, this should not be construed as limitation on the scope of the present invention. Accordingly, the scope of the present invention should be determined not by the embodiment illustrated, but by the appended claims and their legal equivalents.

1. A solventless thermosetting photosensitive via-filling material, which comprises:
one or more liquid epoxy resins;
one or more monomers;
one or more photo-initiators; and
one or more epoxy resin curing agents.

2. The solventless thermosetting photosensitive via-filling material according to claim 1, wherein said liquid epoxy resins comprise at least one of the compounds selected from a group consisting of bisphenol-A epoxy resins, bisphenol-F epoxy resins, mix of bisphenol-A and bisphenol-F epoxy resins, phenol Novolac epoxy resins, rubber-modified epoxy resins, cycloaliphatic epoxy resins, hydrogenated bisphenol-A epoxy resins, dimmer-modified epoxy resins, flexible EPU modified epoxy resins and other hetero epoxy resins.

3. The solventless thermosetting photosensitive via-filling material according to claim 1, wherein said monomers comprise at least one of the compounds selected from a group consisting of mono-functional monomer, difunctional monomer, trifunctional monomer and tetra & penta-functional monomer.

4. The solventless thermosetting photosensitive via-filling material according to claim 3, wherein said mono-functional monomer is selected from the group consisting of allyl methacrylate, tetrahydrofurfuryl methacrylate, 2(2-thoxyethoxy)ethyl acrylate, 2-phenoxyethyl acrylate, and isodecyl acrylate.

5. The solventless thermosetting photosensitive via-filling material according to claim 3, wherein said difunctional monomer is selected from the group consisting of tetraethylene glycol dimethylacrylate, polyethylene glycol dimethacrylate, ethylene glycol dimethacrylate, triethylene glycol dimethacrylate, tetraethylene glycol diacrylate, triethylene glycol diacrylate and tripropylene glycol diacrylate.

6. The solventless thermosetting photosensitive via-filling material according to claim 3, wherein said trifunctional monomer is selected from the group consisting of trimethylolpropane trimethacrylate, trimethylolpropane triacrylate and tris(2-hydroxyethyl) isocyanurate triacrylate.

7. The solventless thermosetting photosensitive via-filling material according to claim 3, wherein said tetra & penta-functional monomer is selected from the group consisting of dipentaerythritol pentaacrylate, pentaerythritol tetraacrylate, di-trimethylolpropane tetraacrylate.

8. The solventless thermosetting photosensitive via-filling material according to claim 1, wherein said monomer is added to an amount of 5-50 parts by weight, based on 100 parts by weight of said liquid epoxy resin.

9. The solventless thermosetting photosensitive via-filling material according to claim 1, wherein said photo-initiator comprises free-radical photo-initiators.

10. The solventless thermosetting photosensitive via-filling material according to claim 9, wherein said free radical photo-initiator comprise at least one of the compounds selected from a group consisting of 2-methyl-1-[4-(methylthio)phenyl]-2-morpholinopropanone, 2-isopropyl thioxanthone, 2-hydroxy-2-methylphenylpropanone, 1-hydroxycyclohexyl phenylketone.

11. The solventless thermosetting photosensitive via-filling material according to claim 1, wherein said photo-initiator is added to an amount of 1-10 parts by weight, based on 100 parts by weight of said liquid epoxy resin.

12. The solventless thermosetting photosensitive via-filling material according to claim 1, wherein said epoxy resin curing agent comprises epoxy resin thermal curing agent.

13. The solventless thermosetting photosensitive via-filling material according to claim 12, wherein said epoxy resin thermal curing agent comprise at least one of the compounds selected from a group consisting of dicyandiamine, amidoamines, polysulfides, amines, polyamides, aliphatic amines, cycloaliphatic amines, aromatic amines, anhydrides, imidazoles, modified polyamine and Adeka EH-4337S.

14. The solventless thermosetting photosensitive via-filling material according to claim 13, wherein said imidazole is selected from a group consisting of 2-methylimidazole 2,4-diamino-6-(2′-methylimidazolyl-(1′))-ethyl-S-triazine, 2,4-diamino-6[2′-methylimidazoly-(1′).] ethyl-S-triazine isocyanuric acid addition compound.

15. The solventless thermosetting photosensitive via-filling material according to claim 13, wherein said modified polyamine is selected from a group consisting of Adeka EH-4070S, Air Products Ancamine-2014FG.

16. The solventless thermosetting photosensitive via-filling material according to claim 1, wherein said epoxy resin curing agent is added to an amount of 1-60 parts by weight, based on 100 parts by weight of said liquid epoxy resin.

17. The solventless thermosetting photosensitive via-filling material according to claim 1, further comprising one or more inorganic fillers.

18. The solventless thermosetting photosensitive via-filling material according to claim 17, wherein said inorganic filler is selected from a group consisting of silicon dioxide, barium sulfate, mica and talcum powder.

19. The solventless thermosetting photosensitive via-filling material according to claim 18, wherein said inorganic filler is added to an amount of 0-200 parts by weight, based on 100 parts by weight of said liquid epoxy resin.

20. The solventless thermosetting photosensitive via-filling material according to claim 1, further comprising one or more organic adjuvants.

21. The solventless thermosetting photosensitive via-filling material according to claim 20, wherein said organic adjuvant comprises a de-foaming agent.

22. The solventless thermosetting photosensitive via-filling material according to claim 20, wherein said organic adjuvant comprises a thixotropic agent.

23. The solventless thermosetting photosensitive via-filling material according to claim 20, wherein said organic adjuvant comprises a leveling agent.

24. The solventless thermosetting photosensitive via-filling material according to claim 20, wherein said organic adjuvant comprises a rheological adjuvant.

25. The solventless thermosetting photosensitive via-filling material according to claim 20, wherein said organic adjuvant comprises a dye.

26. The solventless thermosetting photosensitive via-filling material according to claim 20, wherein said organic adjuvant is added to an amount of 0-50 parts by weight, based on 100 parts by weight of said liquid epoxy resin.
